(19) United States
(12) Patent Application Publication
(10) Pub. No.: US 2025/0304092 A1
(43) Pub. Date: Oct. 2, 2025

(54) DRIVING ASSISTANCE DEVICE, VEHICLE, CONTROL METHOD FOR DRIVING ASSISTANCE DEVICE, AND STORAGE MEDIUM

(71) Applicant: HONDA MOTOR CO., LTD., Tokyo (JP)

(72) Inventors: Misako KOIKE, Wako-shi (JP); Kosuke NAKANISHI, Wako-shi (JP); Gakuyo FUJIMOTO, Wako-shi (JP)

(21) Appl. No.: 19/046,970

(22) Filed: Feb. 6, 2025

(30) Foreign Application Priority Data
Mar. 28, 2024 (JP) 2024-054472

(51) Int. Cl. B60W 50/14

(52) U.S. Cl. CPC B60W 50/14; B60W 2050/146; B60W 2540/225

(57) ABSTRACT

A driving assistance device comprising: a detection unit configured to detect a line-of-sight direction or a face direction of a driver of a vehicle; a first determination unit configured to determine whether or not the driver has viewed a specific position of a periphery checking device provided in the vehicle by determining whether or not a predetermined range from a center in the line-of-sight direction is included in the specific position; a second determination unit configured to determine that a vehicle peripheral region checkable by the periphery checking device has been viewed in a case where it is determined that the specific position has been viewed; and a third determination unit configured to determine whether or not the driver has viewed a lateral region lateral to the vehicle based on the face direction.

### CROSS-REFERENCE TO RELATED APPLICATION(S)

This application claims priority to and the benefit of Japanese Patent Application No. 2024-054472 filed on Mar. 28, 2024, the entire disclosure of which is incorporated herein by reference.

### BACKGROUND OF THE INVENTION

### Field of the Invention

The present invention relates to a driving assistance device, a vehicle, a control method for the driving assistance device, and a storage medium.

### Description of the Related Art

Japanese Patent Laid-Open No. 2022-087117 discloses determining whether or not the line of sight of a driver is directed to a side mirror, assessing whether or not the driver is viewing an obstacle using together information other than the line of sight, and alerting the driver.

However, the technique described in Japanese Patent Laid-Open No. 2022-087117 has a problem that it cannot be determined whether or not the driver has viewed a region lateral to the vehicle.

### SUMMARY OF THE INVENTION

The present invention has been made in view of the above problems, and provides a technique for easily determining whether or not a driver has checked regions in a plurality of directions including a region lateral to the vehicle.

According to one aspect of the present invention, there is provided a driving assistance device comprising: a detection unit configured to detect a line-of-sight direction or a face direction of a driver of a vehicle; a first determination unit configured to determine whether or not the driver has viewed a specific position of a periphery checking device provided in the vehicle by determining whether or not a predetermined range from a center in the line-of-sight direction is included in the specific position; a second determination unit configured to determine that a vehicle peripheral region checkable by the periphery checking device has been viewed in a case where it is determined that the specific position has been viewed; and a third determination unit configured to determine whether or not the driver has viewed a lateral region lateral to the vehicle based on the face direction.

### BRIEF DESCRIPTION OF THE DRAWINGS

FIG. 1 is a block diagram of a vehicle and a control device according to an embodiment;

FIG. 2 is a flowchart illustrating a procedure of processing performed by a driving assistance device according to the embodiment;

FIG. 3 is a diagram illustrating an example of a rear lateral region with respect to the vehicle according to the embodiment;

FIG. 4 is a diagram illustrating an example of a specific position set in a side mirror according to the embodiment;

FIG. 5 is a diagram illustrating an example of a specific position set in a monitor according to the embodiment;

FIG. 6 is a diagram illustrating an example of left and right lateral regions with respect to the vehicle according to the embodiment;

FIG. 7 is an explanatory diagram of movement of a face according to the embodiment;

FIG. 8 is an explanatory diagram of a line-of-sight range in a vertical direction of a driver according to the embodiment;

FIG. 9 is an explanatory diagram of a line-of-sight range in a left-right direction of the driver according to the embodiment;

FIG. 10 is a diagram illustrating a setting example of a front region at the time of right turn and left turn according to a modification;

FIG. 11 is an explanatory diagram of a notification condition at the time of right turn and left turn of the vehicle according to the embodiment;

FIG. 12 is an explanatory diagram of a notification condition in a case where a forward vehicle is present in front of the vehicle according to the embodiment; and

FIG. 13 is an explanatory diagram of a notification condition in a case where a pedestrian enters a predetermined area in front of the vehicle according to the embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### <Control Device and Application Example Thereof>

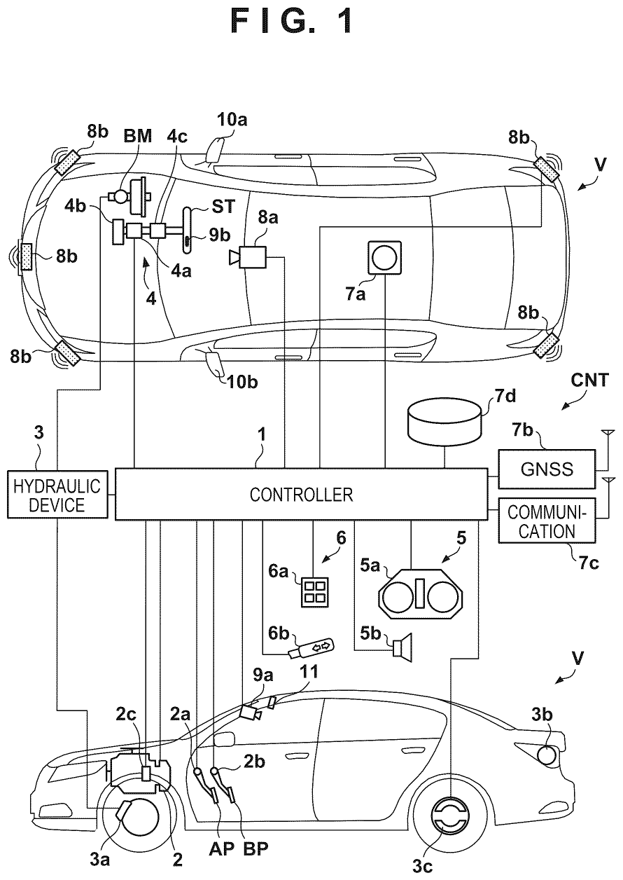

FIG. 1 is a block diagram of a control device CNT according to an embodiment of the present invention and also a schematic diagram of a vehicle V which is an application example of the control device CNT. In FIG. 1, an outline of the vehicle Vis illustrated in a plan view and a side view. The vehicle V according to the present embodiment is, for example, a sedan-type four-wheeled passenger vehicle, and may be, for example, a parallel hybrid vehicle. Note that the vehicle V is not limited to the four-wheeled passenger vehicle, and may be a straddle type vehicle (motorcycle, three-wheeled vehicle) or a large vehicle such as a truck or a bus.

The control device CNT includes a controller 1 which is an electronic circuit that performs control of the vehicle V including driving assistance of the vehicle V. The controller 1 includes a plurality of electronic control units (ECUs). For example, the ECUs are provided for each function of the control device CNT. Each ECU includes a processor represented by a central processing unit (CPU), a storage device such as a semiconductor memory, an interface with an external device, and the like. The storage device stores a program to be executed by the processor, data used for processing by the processor, and the like. The interface includes an input/output interface and a communication interface. Each ECU may include a plurality of processors, a plurality of storage devices, and a plurality of interfaces. A program to be stored in the storage device may be installed in the control device CNT via a storage medium such as a CD-ROM and thereby stored in the storage device.

The controller 1 controls driving (acceleration) of the vehicle V by controlling a power unit (power plant) 2. The power unit 2 is a travel driving unit that outputs driving force for rotating drive wheels of the vehicle V and can include an internal combustion engine, a motor, and an automatic transmission. The motor can be used as a drive source for accelerating the vehicle V and can also be used as a generator at the time of deceleration or the like (regenerative braking).

In the present embodiment, the controller 1 controls the outputs of the internal combustion engine and the motor and switches the gear range of the automatic transmission, for example, in response to driver's driving operation detected by an operation sensor 2a provided in an accelerator pedal AP and by an operation sensor 2b provided in a brake pedal BP and in accordance with a speed of the vehicle V detected by a rotation speed sensor 2c. Note that the rotation speed sensor 2c that detects the rotation speed of the output shaft of the automatic transmission is provided in the automatic transmission as a sensor for detecting the traveling state of the vehicle V. The vehicle speed of the vehicle V can be calculated from a detection result of the rotation speed sensor 2c.

The controller 1 controls braking (deceleration) of the vehicle V by controlling a hydraulic device 3. The driver's braking operation on the brake pedal BP is converted into hydraulic pressure in a brake master cylinder BM and transmitted to the hydraulic device 3. The hydraulic device 3 is an actuator capable of controlling a hydraulic pressure of a hydraulic oil supplied to a brake device 3a (for example, a disc brake device) provided on each of the four wheels on the basis of the hydraulic pressure transmitted from the brake master cylinder BM.

The controller 1 can control braking of the vehicle V by performing drive control of an electromagnetic valve or the like included in the hydraulic device 3. The controller 1 can also configure an electric servo brake system by controlling the distribution of the braking force by the brake device 3a and the braking force by the regenerative braking of the motor included in the power unit 2. The controller 1 may turn on a brake lamp 3b at the time of braking.

The controller 1 controls the steering of the vehicle V by controlling an electric power steering device 4. The electric power steering device 4 includes a mechanism for steering front wheels in response to a driver's driving operation (steering operation) on a steering wheel ST. The electric power steering device 4 includes a drive unit 4a that exerts a driving force (sometimes referred to as steering assist torque) for assisting the steering operation or automatically steering the front wheels of the vehicle V. The drive unit 4a includes a motor as a drive source. In addition, the electric power steering device 4 further includes a steering angle sensor 4b that detects a steering angle, and a torque sensor 4c that detects steering torque (also, referred to as steering load torque, and is distinguished from steering assist torque) applied to the driver.

The controller 1 controls electric parking brake devices 3c provided in the rear wheels of the vehicle V, respectively. Each of the electric parking brake devices 3c includes a mechanism for locking a corresponding rear wheel. The controller 1 can control locking and unlocking of the rear wheel by the electric parking brake device 3c.

The controller 1 controls an information output device 5 that gives information to the inside of the vehicle. The information output device 5 includes, for example, a display device 5a that notifies the driver of information by an image and/or a voice output device 5b that notifies the driver of information by a voice. Examples of the display device 5a include a display device provided in an instrument panel and a display device provided in the steering wheel ST. In addition, the display device 5a may include a head-up display. The information output device 5 may provide information to the occupant using vibration or light.

The controller 1 receives an instruction input by the occupant (e.g., driver) via an input device 6. The input device 6 is disposed at a position operable by the driver, and includes, for example, a switch group 6a for the driver to instruct the vehicle V and/or a blinker lever 6b for operating a direction indicator (blinker).

The controller 1 recognizes and determines a current position and a course (attitude) of the vehicle V. In the present embodiment, the vehicle Vis provided with a gyro sensor 7a, a global navigation satellite system (GNSS) sensor 7b, and a communication device 7c. The gyro sensor 7a detects a rotational motion (yaw rate) of the vehicle V. The GNSS sensor 7b detects a current position of the vehicle V. The communication device 7c wirelessly communicates with a server that can provide map information and traffic information and then acquires such information. In the present embodiment, the controller 1 determines the course of the vehicle V based on detection results of the gyro sensor 7a and the GNSS sensor 7b. In addition, the controller 1 sequentially acquires map information about the course from the server via the communication device 7c and stores the map information in a database 7d (storage device). Note that the vehicle V may be provided with another sensor for detecting the state of the vehicle V, such as an acceleration sensor for detecting the acceleration of the vehicle V.

The controller 1 assists the driving of the vehicle V on the basis of the detection results of various detection units provided in the vehicle V. The vehicle V includes surrounding detection units 8a and 8b serving as an external sensor that detects the state outside the vehicle V (surrounding situation), and vehicle interior detection units 9a and 9b serving as an in-vehicle sensor that detects a state inside the vehicle (the state of occupants, particularly, the driver). The controller 1 can grasp the surrounding situation around the vehicle V based on the detection results of the surrounding detection units 8a and 8b and then assist the driving in accordance with the surrounding situation. In addition, the controller 1 can determine whether or not the driver is performing a predetermined operation obligation imposed on the driver when assisting the driving on the basis of the detection results of the vehicle interior detection units 9a and 9b.

The surrounding detection unit 8a is an imaging device (hereinafter, sometimes referred to as front camera 8a) that captures an image of a region in front of the vehicle V, and is attached to the vehicle interior side of a windshield at the front part of the roof of the vehicle V, for example. The controller 1 can extract a contour of a target or a lane marking (such as a white line) on a road by analyzing an image captured by the front camera 8a.

The surrounding detection unit 8b which is a millimeter wave radar (hereinafter, sometimes referred to as radar 8b) detects a target around the vehicle V using radio waves and detects (measures) a distance to the target and a direction (azimuth) of the target with respect to the vehicle V. In the example illustrated in FIG. 1, five radars 8b are provided, one at the center of the front part of the vehicle V, one at each of the left and right corners of the front part, and one at each of the left and right corners of the rear part.

Note that the surrounding detection unit provided in the vehicle Vis not limited to the above configuration, and the number of cameras and the number of radars may be changed, or a light detection and ranging (LIDAR) for detecting a target around the vehicle V may be provided.

The vehicle interior detection unit 9a is an imaging device (hereinafter, sometimes referred to as in-vehicle camera 9a) that images the interior of the vehicle, and is attached to, for example, the vehicle interior side at the front part of the roof of the vehicle V. In the present embodiment, the in-vehicle camera 9a is a driver monitor camera that images the driver (for example, driver's eye and face). The controller 1 can determine the direction of the line of sight and the face (line-of-sight direction and face direction) of the driver by analyzing an image (facial image of the driver) captured by the in-vehicle camera 9a.

The vehicle interior detection unit 9b is a grip sensor (hereinafter, sometimes referred to as a grip sensor 9b) that detects grip of the steering wheel ST by the driver, and is provided in at least a part of the steering wheel ST, for example. As the vehicle interior detection unit, a torque sensor 4c that detects the steering torque of the driver may be used.

A right side mirror 10a is a mirror disposed on the right side of the vehicle V and having a mirror surface region. A left side mirror 10b is a mirror disposed on the left side of the vehicle V and having a mirror surface region. A rearview mirror 11 is a mirror with a mirror surface region attached to the vehicle interior side at the front part of the roof of the vehicle V.

Note that an electronic mirror may be provided instead of the right side mirror 10a, the left side mirror 10b, and the rearview mirror 11. That is, instead of the right side mirror 10a and the left side mirror, a monitor for displaying an image captured by a camera (not illustrated), which is disposed on the left and right sides of the vehicle and captures a rear lateral region with respect to the vehicle, may be provided. The monitor may be disposed inside the vehicle. Similarly, instead of the rearview mirror, a monitor for displaying an image captured by a camera (not illustrated) that captures an image of a region behind the vehicle may be provided.

Each of the right side mirror 10a, the left side mirror 10b, and the rearview mirror 11 (or each monitor) functions as a periphery checking device provided in the vehicle. Various vehicle peripheral regions (right rear lateral region, left rear lateral region, and rear region) can be checked by using the periphery checking device. The vehicle peripheral regions will be described in detail later.

### <Driving Assistance>

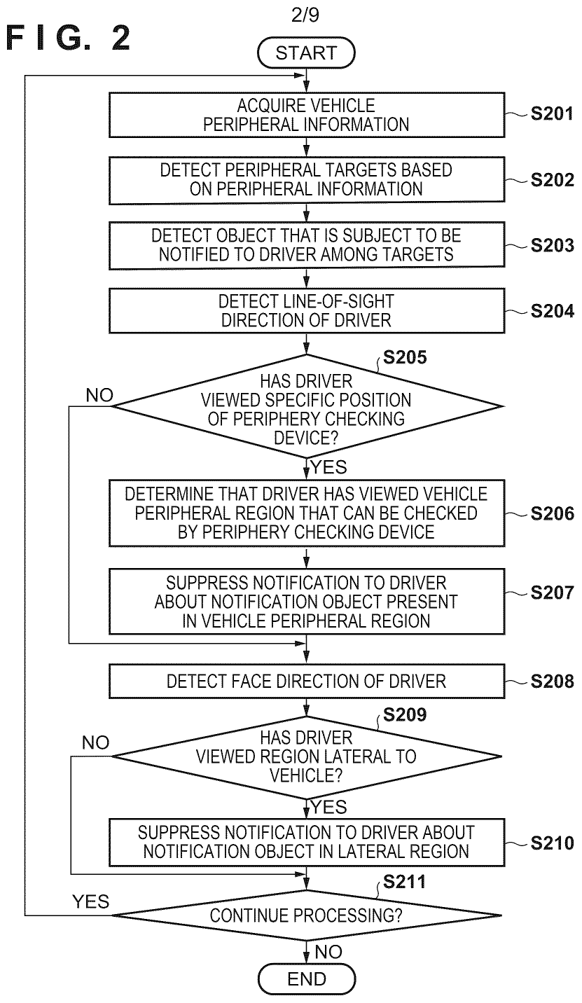

FIG. 2 is a flowchart illustrating a processing example of driving assistance control executed by the ECU included in the controller 1 according to the present embodiment. In the present embodiment, the controller 1 operates as a driving assistance device.

In S201, the ECU acquires peripheral information regarding the periphery of the vehicle V using the surrounding detection units 8a and 8b serving as external sensors for detecting the situation outside the vehicle V (surrounding situation). Note that the peripheral information is continuously acquired at all times.

In S202, the ECU detects one or more targets present around the vehicle V based on the peripheral information acquired in S201. Here, the targets may include various objects such as a signal, a road sign, a forward vehicle, a rearward vehicle, an adjacent vehicle, a bicycle, a pedestrian, and a running person (runner).

In S203, the ECU detects (specifies) a notification object that is a subject to be notified to the driver among the targets detected in S202. The notification to the driver is a notification for alerting the driver, and can be provided using voice and/or display via the information output device 5. The notification is provided when a notification condition is satisfied. The case where the notification condition is satisfied can be, for example, a case where the notification object suddenly approaches the vehicle V, or a case where a relative position (point) or trajectory (movement trajectory) with respect to the vehicle V greatly changes. The notification condition will be described in detail later. The notification object is, for example, a traffic participant present around the vehicle V, and examples thereof include a four-wheeled vehicle, a motorcycle, a pedestrian, a bicycle, and a runner around the vehicle V.

In S204, the ECU detects the line-of-sight direction of the driver by analyzing the image (facial image of the driver) captured by the in-vehicle camera 9a.

In S205, the ECU determines whether or not the driver has viewed the specific position of the periphery checking device on the basis of the detected line-of-sight direction. In a case where the determination in this step is Yes, the processing proceeds to S206. On the other hand, in a case where the determination in this step is No, the processing proceeds to S208.

For example, the ECU determines whether or not a predetermined range from the center in the detected line-of-sight direction is included in the specific position of the periphery checking device provided in the vehicle, thereby determining whether or not the driver has viewed the specific position. Here, the predetermined range from the center in the line-of-sight direction can be, for example, an area (central vision area) within a range of a predetermined angle (for example, 2°) from the center of the line of sight.

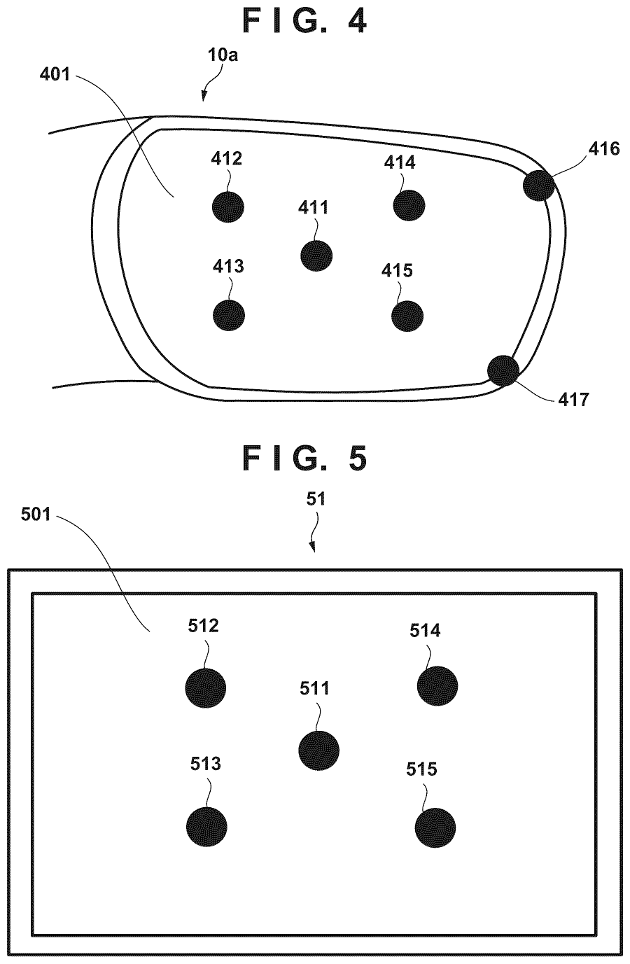

In the description of the present embodiment, the right side mirror 10a is mainly used as the periphery checking device, but the processing according to the present embodiment is similarly performed on the periphery checking device other than the right side mirror 10a. The specific position of the right side mirror 10a may be, for example, at least one of a plurality of points 411 to 417 set in a mirror surface region 401 of the right side mirror 10a illustrated in FIG. 4. The plurality of points 411 to 417 may include end points 416 and 417 of the mirror surface region 401 located farther from the vehicle V. The plurality of points 411 to 417 may further include a center point 411 of the mirror surface region 401 and one or more points 412 to 415 around the center point 411 in the mirror surface region.

The vehicle body of the vehicle V may appear in the mirror surface region of the right side mirror 10a close to the vehicle V, and thus, the driver who views the point in the mirror surface region close to the vehicle V may not view the right rear lateral region. On the other hand, when the driver has viewed a point on the mirror surface region farther from the vehicle V or the vicinity thereof, it can be determined that the driver views the right rear lateral region.

In view of this, the end points 416 and 417 located farther from the vehicle V in the mirror surface region 401 are used as the specific position of the right side mirror 10a in addition to the center point 411 and the plurality of points 412 to 415 around the center point 411. This enables control more appropriate for the actual driving situation. The specific position of the left side mirror 10b may be provided symmetrically with the specific position of the right side mirror 10a.

Note that, in a case where, instead of the side mirrors, a monitor 51 that is installed on each of the left and right sides of the vehicle and displays a video captured by a camera (not illustrated) that captures the rear lateral region with respect to the vehicle is installed as the periphery checking device, a specific position as illustrated in FIG. 5 can be set. In the case of using the monitor 51, the camera (not illustrated) can be disposed such that the vehicle body of the vehicle V hardly appears in the camera. Therefore, unlike the side mirrors, the specific position may be at least one of a plurality of points 511 to 515 set in a video display region 501 of the monitor 51. That is, an end point as the specific position may not be provided at the end of the monitor 51. However, in the case of using the monitor, points corresponding to the points 416 and 417 illustrated in FIG. 4 may also be set at the end of the monitor 51 as in the side mirror.

When the periphery checking device is the rearview mirror 11 for checking the region behind the vehicle V, the specific position may be at least one of a plurality of points set in the mirror surface region of the rearview mirror 11. The plurality of points may be arranged in a similar manner to those of the monitor 51.

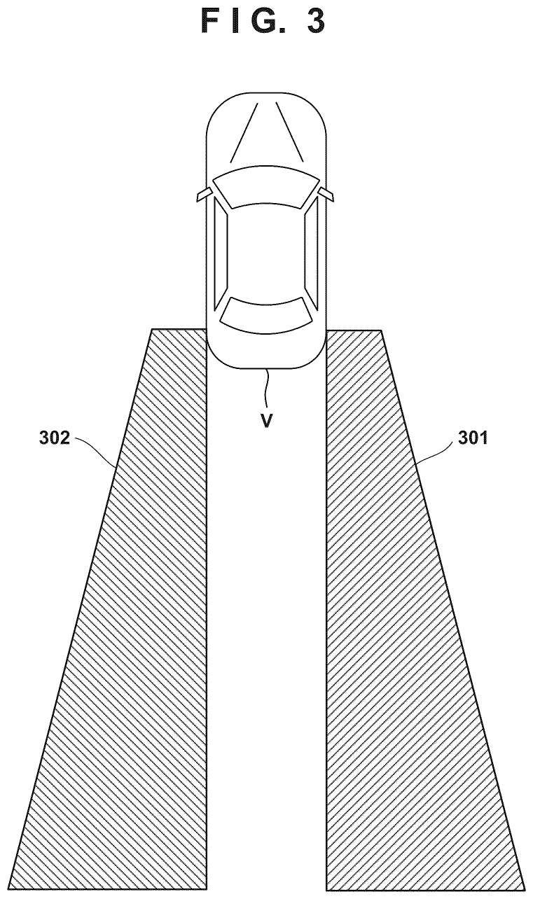

In S206, the ECU determines that the driver has viewed a vehicle peripheral region that can be checked by the periphery checking device. Here, an example of the vehicle peripheral region according to the present embodiment will be described with reference to FIG. 3. In a case where the periphery checking device is the right side mirror 10a, the vehicle peripheral region is, for example, a right rear lateral region 301. In a case where the periphery checking device is the left side mirror 10b, the vehicle peripheral region is, for example, a left rear lateral region 302. In a case where the periphery checking device is the rearview mirror 11, the vehicle peripheral region may be a rear region (not illustrated). For example, the rear region (not illustrated) is a region between the right rear lateral region 301 and the left rear lateral region 302.

In S207, the ECU suppresses notification about a notification object present in the vehicle peripheral region. Since it is considered that the driver has already checked the notification object present in the vehicle peripheral region, providing a notification about such a notification object may bother the driver. The above-mentioned processing can suppress excessive notification to the driver. Note that the suppression of notification may be canceled in response to the driver removing his/her gaze from the periphery checking device or when a predetermined time has elapsed after the driver removes his/her gaze.

In S208, the ECU detects the face direction of the driver by analyzing an image (facial image of the driver) captured by the in-vehicle camera 9a.

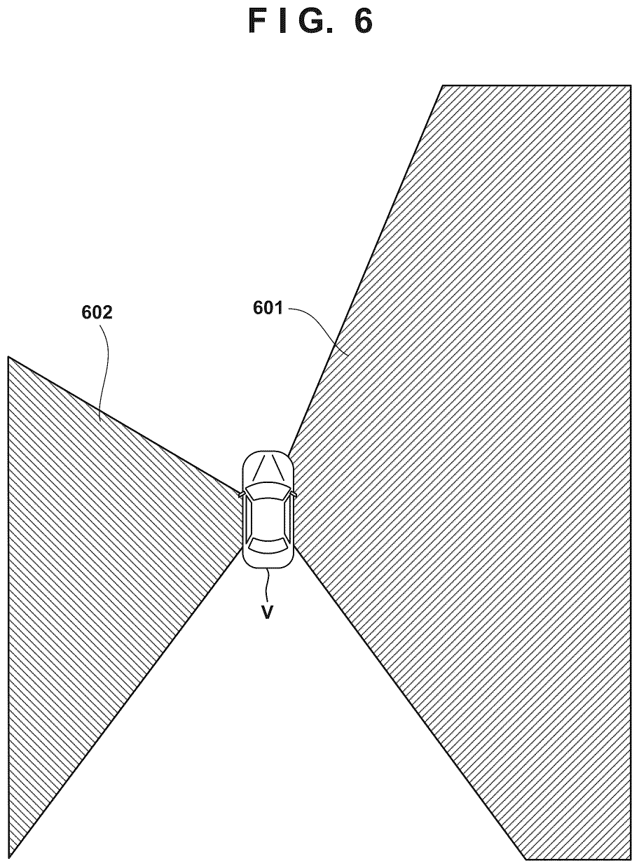

In S209, the ECU determines whether or not the driver has viewed a lateral region lateral to the vehicle V on the basis of the detected face direction. In a case where the determination in this step is Yes, the processing proceeds to S210. On the other hand, in a case where the determination in this step is No, the processing proceeds to S211. Here, the lateral region is a right lateral region or a left lateral region. FIG. 6 is a diagram illustrating an example of the lateral region according to the present embodiment. FIG. 6 illustrates a right lateral region 601 and a left lateral region 602. The right lateral region 601 is set to be wider than the left lateral region 602. This is because the driver is seated on the right seat in this example. When the driver is seated on the left seat, the right lateral region and the left lateral region may be set reverse to those illustrated in FIG. 6.

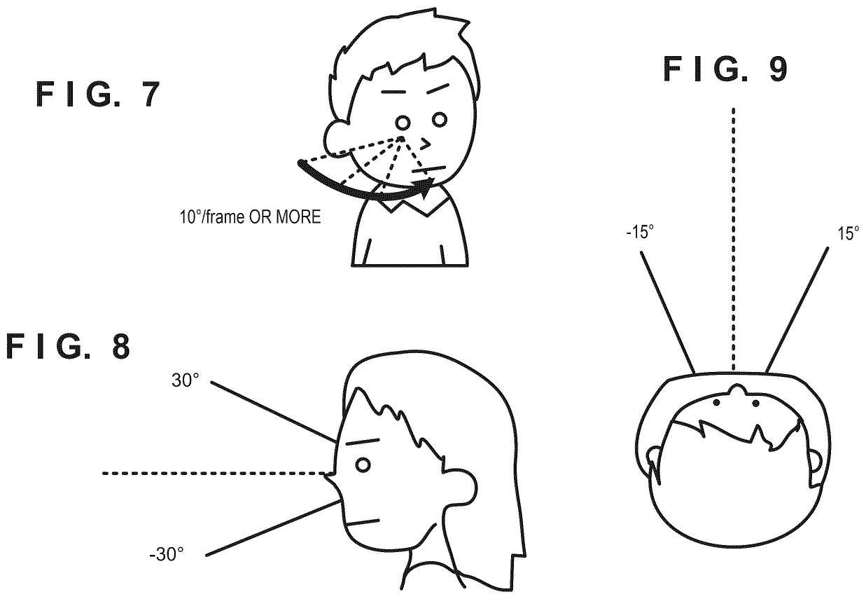

As a first determination method, in a case where the line-of-sight direction is no longer detected, the ECU may determine whether or not the driver has viewed the lateral region based on an amount of temporal change in the face direction before the line-of-sight direction is no longer detected. When the driver turns his/her face toward the lateral region lateral to the vehicle V in order to check the lateral region, the line-of-sight direction cannot be detected after a certain timing. This is because the position imaged by the in-vehicle camera 9a gradually shifts from the front of the face toward the side of the face, so that the detection of the line of sight is limited. Therefore, in the first determination method, it is estimated that the driver has viewed the lateral region from the movement of the face before the line-of-sight direction is no longer detected. More specifically, when the amount of temporal change (for example, a temporal change in the angle of the face direction) is equal to or greater than a threshold, it may be determined that the driver has viewed the lateral region. For example, in a case where the face moves to the left or right at 10°/frame or more as illustrated in FIG. 7, it may be determined that the driver has viewed the lateral region in the moving direction. In the illustrated example, it can be determined that the driver has viewed the left lateral region.

As a second determination method, in a case where the line-of-sight direction is no longer detected, the ECU may determine whether or not the driver has viewed the lateral region based on the line-of-sight direction before the line-of-sight direction is no longer detected.

More specifically, in a case where the line-of-sight direction before the line-of-sight direction is no longer detected is within a first predetermined angular range in the vertical direction of the driver and has an angle equal to or larger than a second predetermined angle in one direction out of the left direction and right direction of the driver, it may be determined that the driver has viewed the lateral region in the one direction. The first predetermined angular range may be, for example, a range of +30° to −30° in the vertical direction (pitch) as illustrated in FIG. 8. Furthermore, the second predetermined angle may be, for example, 15° or more in the left-right direction (yaw) as illustrated in FIG. 9.

That is, in a case where the line-of-sight direction of the driver is within the range of +30° to −30° in the vertical direction (pitch) and in a direction having an angle of +15° or more in the left direction, it may be determined that the driver has viewed the right lateral region. In a case where the line-of-sight direction of the driver is within the range of +30° to −30° in the vertical direction (pitch) and in a direction having an angle of −15° or less in the left direction, it may be determined that the driver has viewed the left lateral region.

In S210, the ECU suppresses the notification to the driver about the notification object in the lateral region which has been determined to be viewed by the driver. Since it is considered that the driver has checked the notification object present in the lateral region, providing a notification about such a notification object may bother the driver. The above-mentioned processing can suppress excessive notification to the driver. Note that the suppression of notification may be canceled when it is determined that the driver is not viewing the lateral region.

In step S211, the ECU determines whether to continue the processing. For example, the processing may be continued while the driver activates the vehicle V (when the engine is on or when the power supply of an electric vehicle is on). In a case where the determination in this step is Yes, the processing returns to S201. On the other hand, in a case where the determination in this step is No, the processing ends. Thus, the processing illustrated in FIG. 2 ends.

### <Example of Notification Condition>

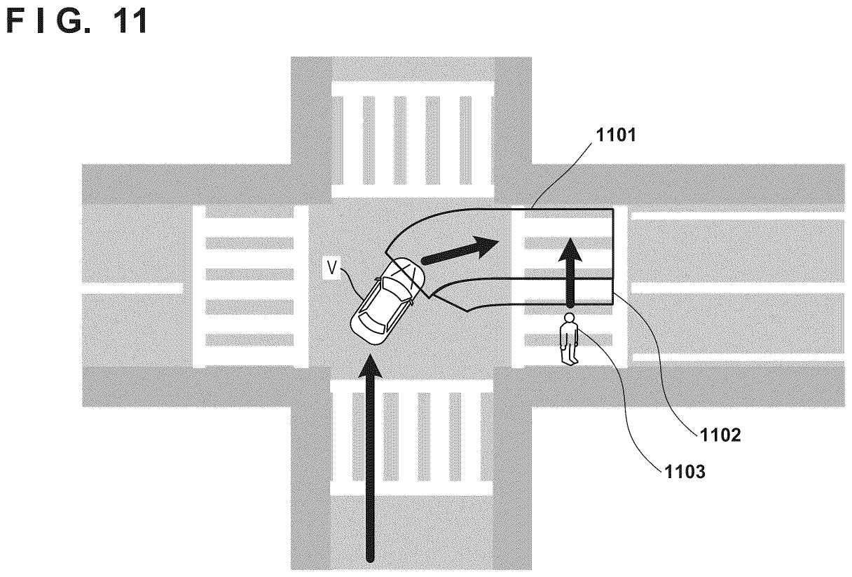

Here, the notification condition may be that an approach of a notification object (for example, a bicycle, a pedestrian, or a runner) to the vehicle Vis detected when the vehicle V turns right or left. For example, the notification condition may be satisfied when it is detected that a notification object (for example, a bicycle, a pedestrian, or a runner) crosses a pedestrian crosswalk while the vehicle V turns right. FIG. 11 is a diagram illustrating a situation where the vehicle V turns right at an intersection. A notification object 1103 is about to cross a pedestrian crosswalk located in a right turn direction. In this case, a warning area 1102 may be set outside a predetermined area 1101 in the traveling direction of the vehicle V, and the notification condition may be satisfied when it is detected that the notification object 1103 has entered the warning area 1102.

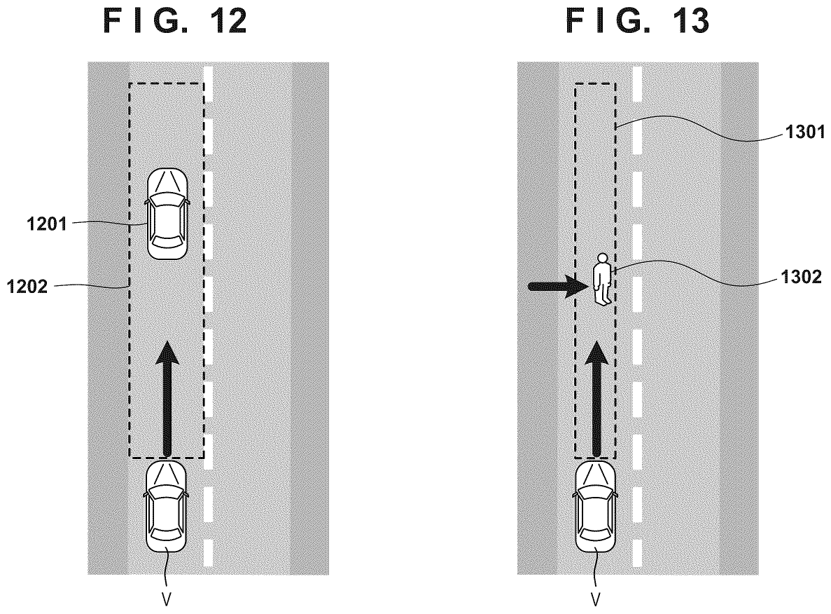

Alternatively, the notification condition may be that Time to Collision (TTC) is equal to or less than a threshold. That is, the notification may be given when a value obtained by dividing a distance between the vehicle V and a notification object (for example, a forward vehicle) present in a predetermined area in the traveling direction of the vehicle by a relative speed between the vehicle and the notification object is equal to or less than a threshold. FIG. 12 is a diagram illustrating a relationship between the vehicle V and a preceding vehicle traveling in front of the vehicle V. The preceding vehicle 1201 is present in a predetermined area 1202 in the traveling direction of the vehicle V. In this case, the TTC may be continuously calculated, and the notification condition may be satisfied when the TTC becomes equal to or less than a threshold. Alternatively, the moving average value of the TTC (the average value of a change in the TTC within a predetermined period) may be constantly calculated, and the notification condition may be satisfied when a second moving average value after a predetermined time (for example, one second) becomes smaller than a first moving average value.

Alternatively, the notification condition may be that the notification object (for example, a bicycle, a pedestrian, or a runner) has entered a predetermined area in the traveling direction of the vehicle V (for example, a predetermined area in front of the vehicle). FIG. 13 is a diagram illustrating a relationship between the vehicle V and a notification object. FIG. 13 illustrates a state in which a notification object 1302 has entered a predetermined area 1301 in the traveling direction of the vehicle V.

In a case where the driver fails to notice the notification object in a situation where the driver has not been able to recognize the notification object that should be checked again, a notification is given to the driver for warning.

As described above, according to the present embodiment, it is possible to appropriately determine whether or not the driver has viewed a lateral region lateral to the vehicle and a rear region behind the vehicle by reflecting the characteristic in which the face direction can be used for determination when the driver checks the lateral region, while the central vision is important when the driver checks the side mirror. Therefore, it is possible to easily determine whether or not the driver has checked regions in a plurality of directions including a lateral region lateral to the vehicle.

### Modifications

The above-described embodiment has described an example in which it is determined whether or not a driver has viewed a vehicle peripheral region (rear lateral region, rear region) or a lateral region lateral to the vehicle that can be checked by a periphery checking device (side mirrors, rearview mirror, monitor, or the like), and when the driver has viewed the vehicle peripheral region or the lateral region, a notification about a notification object in the region is suppressed.

However, suppression of notification is not limited to the rear lateral region, the rear region, and the lateral region lateral to the vehicle. The present modification will describe an example in which it is determined whether or not the driver has viewed a front region in front of the vehicle, and suppression of notification is performed.

The ECU detects a driving operation of the driver. When the right-turn operation is detected as the driving operation, the ECU determines whether or not the driver has viewed a first front region corresponding to the right-turn operation. When the left-turn operation is detected as the driving operation, the ECU determines whether or not the driver has viewed a second front region corresponding to the left-turn operation.

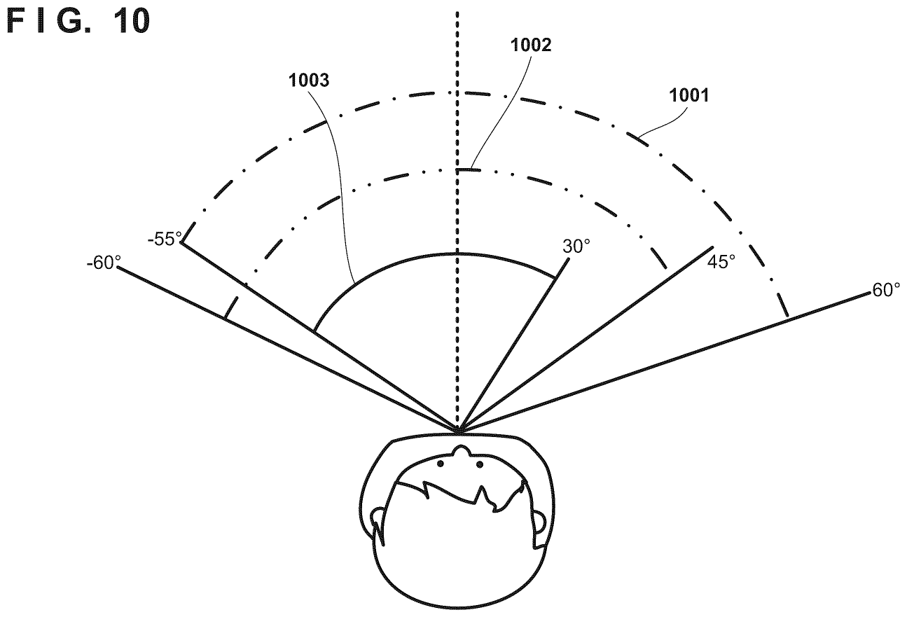

The front region will be described in detail with reference to FIG. 10. The first front region corresponding to the right-turn operation is a front region indicated by an angular range 1001. The angular range 1001 ranges from −55° to 60°. The second front region corresponding to the left-turn operation is a front region indicated by an angular range 1002. The angular range 1002 ranges from −60° to 45°. In this manner, the range of the front region to be set varies between the right turn and the left turn. The angular range 1003 is a range of −55° to 30°, which corresponds to the front region when the vehicle travels straight.

When it is determined that the driver has viewed the first front region, the ECU suppresses notification about the notification object present in the first front region. When it is determined that the driver has viewed the second front region, the ECU suppresses notification about the notification object present in the second front region. The range of the front region to be set varies between the right turn and the left turn, whereby suppression of notification suitable for each of the right turn and the left turn can be achieved. More specifically, the second front region (at the time of left turn) is narrower than the first front region (at the time of right turn), and when the second front region is applied, a notification about the notification object present within an angular range larger than 45° is not suppressed. When turning left, the driver tends to view mainly in the left direction. Therefore, due to control not to suppress the notification about a notification object in a region in the right direction with an angle greater than 45°, the driver can be alerted as appropriate.

In addition, the above-described embodiment has described an example in which, on the assumption that the driver has checked a notification object in response to the driver viewing any of various regions, the notification about the notification object in the region is suppressed. The suppression of notification may be canceled in response to the driver removing his/her gaze from the periphery checking device (corresponding to the right side mirror, for example). However, even when the driver removes his/her gaze, he/she has been able to recognize a notification object in a region (right rear lateral region, for example) corresponding to the periphery checking device in his/her mind. In particular, it is considered that, within a short time after the driver removes his/her gaze from the periphery checking device, the driver can imagine a notification object in the region. Therefore, in a situation where the driver can recognize the notification object in his/her mind without viewing the region, a suppression of notification may be continued. For example, the suppression of notification may be continued until a predetermined time elapses after the driver removes his/her gaze from the periphery checking device. In addition, when it is determined that the driver has again viewed the same periphery checking device within the predetermined time, the suppression of notification about a notification object in the region may be continued. As a result, it is possible to suppress excessive notification in a situation where the driver can recognize the notification object in his/her mind even if he/she is not viewing the notification object.

According to the present invention, it is possible to easily determine whether or not the driver has checked regions in a plurality of directions including a region lateral to the vehicle.

### SUMMARY OF EMBODIMENTS

1. The driving assistance device (1) according to the above embodiment is a driving assistance device comprising:
a detection unit (1, 9) configured to detect a line-of-sight direction or a face direction of a driver of a vehicle (V);
a first determination unit (1) configured to determine whether or not the driver has viewed a specific position of a periphery checking device (101, 10b, 11) provided in the vehicle by determining whether or not a predetermined range from a center in the line-of-sight direction is included in the specific position;
a second determination unit (1) configured to determine that a vehicle peripheral region (301, 302) checkable by the periphery checking device has been viewed in a case where it is determined that the specific position has been viewed; and
a third determination unit (1) configured to determine whether or not the driver has viewed a lateral region (601, 602) lateral to the vehicle based on the face direction.

It is possible to appropriately determine whether or not the driver has viewed a lateral region lateral to the vehicle and a rear region behind the vehicle by reflecting the characteristic in which the face direction can be used for determination when the driver checks the lateral region, while the central vision is important when the driver checks the side mirror. Thus, it is possible to easily determine whether or not the driver has checked regions in a plurality of directions including a region lateral to the vehicle.
2. The driving assistance device (1) according to the above embodiment, further comprising:
an object detection unit (1, 8a˜8b) configured to detect a notification object that is an object to be notified to the driver of the vehicle based on information regarding a periphery of the vehicle; and
a suppression unit (1) configured to suppress notification about the notification object, wherein
the suppression unit suppresses the notification about the notification object present in the vehicle peripheral region in a case where the second determination unit determines that the vehicle peripheral region has been viewed, and suppresses the notification about the notification object present in the lateral region in a case where the third determination unit determines that the lateral region has been viewed.

With this configuration, it is possible to suppress excessive notification for a notification object in a region viewed by the driver.
3. The driving assistance device (1) according to the above embodiment, wherein
the periphery checking device includes a side mirror (10a, 10b) disposed on a side of the vehicle,
the specific position is at least one of a plurality of points (411˜417) set in a mirror surface region of the side mirror, and
the vehicle peripheral region is a rear lateral region (301, 302) with respect to the vehicle.

With this configuration, it can be determined that the side mirror has been properly checked, so that it can be appropriately determined that the driver has viewed the rear lateral region with respect to the vehicle.
4. The driving assistance device (1) according to the above embodiment, wherein the plurality of points includes an end point (416, 417) of the mirror surface region located farther from the vehicle.

With this configuration, it is possible to appropriately determine that the driver has viewed the rear lateral region with respect to the vehicle in consideration of the characteristics of the side mirror (characteristics that the vehicle body may appear in the mirror surface region close to the vehicle body).
5. The driving assistance device (1) according to the above embodiment, wherein the plurality of points further includes a center point (411) of the mirror surface region and one or more points (412˜415) around the center point in the mirror surface region.

With this configuration, it can be appropriately determined that the driver has viewed the rear lateral region with respect to the vehicle.
6. The driving assistance device (1) according to the above embodiment, wherein
the periphery checking device includes a monitor (51) that displays a video obtained by imaging a rear lateral side with respect to the vehicle,
the specific position is at least one of a plurality of points set in a video display region (501) of the monitor, and
the vehicle peripheral region is a rear lateral region with respect to the vehicle.

With this configuration, the above embodiment can also be applied to a so-called mirrorless vehicle. That is, it can be determined that the monitor has been properly checked, so that it can be appropriately determined that the driver has viewed the rear lateral region with respect to the vehicle.
7. The driving assistance device (1) according to the above embodiment, wherein
the periphery checking device includes a rearview mirror (11) for checking a region behind the vehicle,
the specific position is at least one of a plurality of points set in a mirror surface region of the rearview mirror, and
the vehicle peripheral region is a rear region behind the vehicle.

With this configuration, it can be determined that the rearview mirror has been properly checked, so that it can be appropriately determined that the driver has viewed the rear region behind the vehicle.
8. The driving assistance device (1) according to the above embodiment, wherein,
in a case where the line-of-sight direction is no longer detected, the third determination unit determines whether or not the driver has viewed the lateral region based on an amount of temporal change in the face direction before the line-of-sight direction is no longer detected (FIGS. 7-9).

With this configuration, even when the line-of-sight direction of the driver is no longer detected, it is possible to estimate whether or not the driver has viewed the lateral region.
9. The driving assistance device (1) according to the above embodiment, wherein the third determination unit determines that the driver has viewed the lateral region in a case where the amount of temporal change is equal to or greater than a threshold (FIG. 7).

With this configuration, it is possible to estimate that the driver has viewed the lateral region from the movement of the face of the driver before the line-of-sight direction of the driver is no longer detected.
10. The driving assistance device (1) according to the above embodiment, further comprising
a fourth determination unit (1) configured to determine, in a case where the line-of-sight direction is no longer detected, whether or not the driver has viewed the lateral region based on the line-of-sight direction before the line-of-sight direction is no longer detected, wherein,
in a case where the line-of-sight direction before the line-of-sight direction is no longer detected is within a first predetermined angular range in a vertical direction of the driver and has an angle equal to or larger than a second predetermined angle in one direction out of a left direction and a right direction of the driver, the fourth determination unit determines that the driver has viewed the lateral region present in the one direction (FIGS. 8-9).

With this configuration, it is possible to estimate whether or not the driver has viewed the lateral region in consideration of a situation before the line-of-sight direction of the driver is no longer detected.
11. The driving assistance device (1) according to the above embodiment, further comprising:
an operation detection unit (1) configured to detect a driving operation of the driver; and
a fifth determination unit configured to determine whether or not the driver has viewed a first front region (1001) corresponding to a right-turn operation in a case where the right-turn operation has been detected as the driving operation, and determines whether or not the driver has viewed a second front region (1002) corresponding to a left-turn operation in a case where the left-turn operation has been detected as the driving operation, wherein
the suppression unit suppresses the notification about the notification object present in the first front region in a case where it is determined that the first front region has been viewed, and suppresses the notification about the notification object present in the second front region in a case where it is determined that the second front region has been viewed.

With this configuration, it is possible to suppress excessive notification to the driver at the time of right turn or left turn.
12. The driving assistance device (1) according to the above embodiment, wherein the second front region is narrower than the first front region.

It is possible to achieve suppression of notification suitable for the time of right turn or left turn by setting an appropriate region range corresponding to the right turn or the left turn.
13. The vehicle according to the above embodiment is a vehicle comprising the driving assistance device according to the above embodiment.

With this configuration, the function of the driving assistance device according to the above embodiment can be implemented on the vehicle.
14. The control method for a driving assistance device (1) according to the above embodiment is a control method for a driving assistance device, the control method comprising:
detecting (S204, S208) a line-of-sight direction or a face direction of a driver of a vehicle (V);
determining (S205) whether or not the driver has viewed a specific position of a periphery checking device (10a, 10b, 11) provided in the vehicle by determining whether or not a predetermined range from a center in the line-of-sight direction is included in the specific position;
determining (S206) that a vehicle peripheral region (301, 302) checkable by the periphery checking device has been viewed in a case where it is determined that the specific position has been viewed; and
determining (S209) whether or not the driver has viewed a lateral region (601, 602) lateral to the vehicle based on the face direction.
15. The program according to the above embodiment is a program for causing a computer to execute the control method for the driving assistance device according to the above embodiment.

Accordingly, the process of the driving assistance device can be implemented by the computer.
16. The storage medium according to the above embodiment is a storage medium storing a program for causing a computer to execute the control method for the driving assistance device according to the above embodiment.

Accordingly, the process of the driving assistance device can be implemented by the storage medium.

### OTHER EMBODIMENTS

In addition, a program for achieving one or more functions that have been described in each of the embodiments is supplied to a system or an apparatus through a network or via a storage medium, and one or more processors on a computer of the system or the apparatus are capable of reading and executing the program. The present invention is also achievable in such an aspect.

The invention is not limited to the foregoing embodiments, and various variations/changes are possible within the spirit of the invention.

What is claimed is:

1. A driving assistance device comprising:
a detection unit configured to detect a line-of-sight direction or a face direction of a driver of a vehicle;
a first determination unit configured to determine whether or not the driver has viewed a specific position of a periphery checking device provided in the vehicle by determining whether or not a predetermined range from a center in the line-of-sight direction is included in the specific position;
a second determination unit configured to determine that a vehicle peripheral region checkable by the periphery checking device has been viewed in a case where it is determined that the specific position has been viewed; and
a third determination unit configured to determine whether or not the driver has viewed a lateral region lateral to the vehicle based on the face direction.

2. The driving assistance device according to claim 1, further comprising:
an object detection unit configured to detect a notification object that is an object to be notified to the driver of the vehicle based on information regarding a periphery of the vehicle; and
a suppression unit configured to suppress notification about the notification object, wherein
the suppression unit suppresses the notification about the notification object present in the vehicle peripheral region in a case where the second determination unit determines that the vehicle peripheral region has been viewed, and suppresses the notification about the notification object present in the lateral region in a case where the third determination unit determines that the lateral region has been viewed.

3. The driving assistance device according to claim 1, wherein
the periphery checking device includes a side mirror disposed on a side of the vehicle,
the specific position is at least one of a plurality of points set in a mirror surface region of the side mirror, and
the vehicle peripheral region is a rear lateral region with respect to the vehicle.

4. The driving assistance device according to claim 3, wherein the plurality of points includes an end point of the mirror surface region located farther from the vehicle.

5. The driving assistance device according to claim 4, wherein the plurality of points further includes a center point of the mirror surface region and one or more points around the center point in the mirror surface region.

6. The driving assistance device according to claim 1, wherein
the periphery checking device includes a monitor that displays a video obtained by imaging a rear lateral side with respect to the vehicle,
the specific position is at least one of a plurality of points set in a video display region of the monitor, and
the vehicle peripheral region is a rear lateral region with respect to the vehicle.

7. The driving assistance device according to claim 1, wherein
the periphery checking device includes a rearview mirror for checking a region behind the vehicle,
the specific position is at least one of a plurality of points set in a mirror surface region of the rearview mirror, and
the vehicle peripheral region is a rear region behind the vehicle.

8. The driving assistance device according to claim 1, wherein,
in a case where the line-of-sight direction is no longer detected, the third determination unit determines whether or not the driver has viewed the lateral region based on an amount of temporal change in the face direction before the line-of-sight direction is no longer detected.

9. The driving assistance device according to claim 8, wherein the third determination unit determines that the driver has viewed the lateral region in a case where the amount of temporal change is equal to or greater than a threshold.

10. The driving assistance device according to claim 1, further comprising
a fourth determination unit configured to determine, in a case where the line-of-sight direction is no longer detected, whether or not the driver has viewed the lateral region based on the line-of-sight direction before the line-of-sight direction is no longer detected, wherein,
in a case where the line-of-sight direction before the line-of-sight direction is no longer detected is within a first predetermined angular range in a vertical direction of the driver and has an angle equal to or larger than a second predetermined angle in one direction out of a left direction and a right direction of the driver, the fourth determination unit determines that the driver has viewed the lateral region present in the one direction.

11. The driving assistance device according to claim 2, further comprising:
an operation detection unit configured to detect a driving operation of the driver; and
a fifth determination unit configured to determine whether or not the driver has viewed a first front region corresponding to a right-turn operation in a case where the right-turn operation has been detected as the driving operation, and determines whether or not the driver has viewed a second front region corresponding to a left-turn operation in a case where the left-turn operation has been detected as the driving operation, wherein
the suppression unit suppresses the notification about the notification object present in the first front region in a case where it is determined that the first front region has been viewed, and suppresses the notification about the notification object present in the second front region in a case where it is determined that the second front region has been viewed.

12. The driving assistance device according to claim 11, wherein the second front region is narrower than the first front region.

13. A vehicle comprising the driving assistance device according to claim 1.

14. A control method for a driving assistance device, the control method comprising:
detecting a line-of-sight direction or a face direction of a driver of a vehicle;
determining whether or not the driver has viewed a specific position of a periphery checking device provided in the vehicle by determining whether or not a predetermined range from a center in the line-of-sight direction is included in the specific position;
determining that a vehicle peripheral region checkable by the periphery checking device has been viewed in a case where it is determined that the specific position has been viewed; and
determining whether or not the driver has viewed a lateral region lateral to the vehicle based on the face direction.

15. A non-transitory computer-readable storage medium storing a program for causing a computer to execute a control method for a driving assistance device, the control method comprising:
detecting a line-of-sight direction or a face direction of a driver of a vehicle;
determining whether or not the driver has viewed a specific position of a periphery checking device provided in the vehicle by determining whether or not a predetermined range from a center in the line-of-sight direction is included in the specific position;
determining that a vehicle peripheral region checkable by the periphery checking device has been viewed in a case where it is determined that the specific position has been viewed; and
determining whether or not the driver has viewed a lateral region lateral to the vehicle based on the face direction.
